(19) United States
(12) Patent Application Publication
(10) Pub. No.: US 2015/0089328 A1
(43) Pub. Date: Mar. 26, 2015

(54) Flex Erasure Coding of Controllers of Primary Hard Disk Drives Controller

(71) Applicant: Futurewei Technologies, Inc., Plano, TX (US)

(72) Inventors: Xiaobing Lee, Santa Clara, CA (US); Chunlei Dong, San Jose, CA (US); Yong Chen, Redmond, CA (US); Jinshui Liu, Plano, TX (US)

(21) Appl. No.: 14/494,326

(22) Filed: Sep. 23, 2014

Related U.S. Application Data
(60) Provisional application No. 61/881,300, filed on Sep. 23, 2013.

(51) Int. Cl. G06F 11/10

(52) U.S. Cl. CPC G06F 11/1096
USPC 714/770

(57) ABSTRACT

System and method embodiments are provided for managing storage systems. In an embodiment, a storage system includes an over-provisioned redundant array of independent disks (RAID); and a flexible erasure coding controller coupled to the RAID, the controller comprising a flexible exclusive-or engine configured to provide erasure coding for the over-provisioned RAID using M-parity convolution codes.

### CROSS-REFERENCE TO RELATED APPLICATIONS

The present application claims the benefit of U.S. Provisional Patent Application No. 61/881,300 filed Sep. 23, 2013 and entitled “Flex Erasure Coding of Controllers of Primary Hard Disk Drives Controller,” which is incorporated herein by reference as if reproduced in its entirety.

### TECHNICAL FIELD

The present invention relates to hard disk drive systems and methods, and, in particular embodiments, to flex erasure coding of controllers of primary hard disk drives controller.

### BACKGROUND

As hard disk drive (HDD) capacity increases, e.g., to 3 TB and beyond, redundant array of independent disks (RAID) 5/6 cannot provide enough reliability, especially at rebuilding failed disks. RAID5/6 and 3-copy methods waste too much time to blankly rebuild the entire disks, when most of the rebuilt blocks could be deleted without any further accesses, and lack of or low availability of rebuilding disks in case of 2 failures. For example, 20% of primary storage contents/objects could be cold but have to be kept forever. 60% of them would occasionally be accessed before being deleted or replaced. 20% of them are really hot and being constantly read or read-modified-write accessed. The higher the total capacity, the lower percentage of hot blocks that could be involved, daily.

Disk I/O sustained bandwidth becomes a bottleneck as HDDs are doubling their capacity and connectivity about every 1.5-2 years, and need more effective erasure coding (EC). System reliability is related to cost, however, and most of primary storages are designed to just meet the minimum reliability by sacrificing HDD overall availability.

### SUMMARY

In an embodiment, a storage system includes an over-provisioned redundant array of independent disks (RAID); and a flexible erasure coding controller coupled to the RAID, the controller comprising a flexible exclusive-or engine configured to provide erasure coding for the over-provisioned RAID using M-parity convolution codes.

In an embodiment, a method of managing storage in a data processing system includes protecting static blocks in the RAID with over-provisioning of over-provisioned parity disks; coding the RAID with a flexible erasure coding with M-parity convolution codes (MPCC); rebuilding a dead block in the RAID on-the-fly when the block is read; and using, for hot blocks, over-provisioned parity blocks as spare blocks to save just-being-rebuilt blocks for further normal reads. The flex redundancy M parities reduced by 1 with one rebuilt block for one dead block, and so on, with more rebuilt blocks for more dead blocks. For cold data, there are M parities to protect them to tolerate M dead blocks, until they be read and become hot blocks.

In an embodiment, a network component configured to manage a cloud storage system includes a processor; networking gears; and a computer readable storage medium storing programming for execution by the processor, the programming including instructions to: over-provision a redundant array of independent disks (RAID) with over-provisioned parity disks to protect static blocks in the RAID over the cloud storage system; code the RAID with a flexible erasure coding with M-parity convolution codes (MPCC); rebuild a dead block in the RAID on-the-fly when the block is read; and use, for hot blocks, over-provisioned parity blocks as spare blocks to save just-being-rebuilt blocks for further normal reads without repeating MPCC rebuild computation and networking resources. Two layer MPCC protections can be archived within a local RAID HDDs and cross-over cloud storage nodes.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates 24 HDDs set up for two of (10+1) RAID5, (20+2) RAID6 with one spare disk where P₂₀=Pₑᵥₑₙ xor P_{odd};

FIG. 2 illustrates a block diagram of Flex-EoC (20+4) EC and ARM-NEON for open-source software EC;

FIG. 3 illustrates a first (N+3) MPCC mode for basic concept;

FIG. 4 illustrates a second (N+3) MPCC mode for syndrome cancellation then self-auto-correlation;

FIG. 5 illustrates a third (N+4) MPCC mode for simple equal-length 4-parities;

FIGS. 6-9 illustrate a Flex-EoC (20+4) MPCC having a (20+4) MPCC degraded (20+x) MPCC with (4-x) failures for adjacent stripes with hot and cold dead blocks;

FIG. 10 illustrates Flex-EoC low-latency mode having a four (5+2) MPCC hybrid with a (20+x) MPCC;

FIG. 11 is the workflows of the flex erasure coding method to protect cold blocks and rebuild hot blocks of the dead HDDs without maintenance nor rebuilding entire HDD; and

FIG. 12 is a block diagram of a processing system that may be used for implementing the devices and methods disclosed herein.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

An embodiment provides flex erasure code of next generation HDD controller by over-provisioning reliability methods to reduce HDDs primary storage costs and to improve HDDs' availability with much higher reliability without changing bad HDDs maintenances. An embodiment flex erasure coding of controllers (Flex-EoC) may be optimized for next generation HDD controllers.

An embodiment flex-EoC consists of the M-parity convolution code (MPCC) engines for fast EC decoding and the ARM-NEON cores for open-source erasure-codings and RAID6. The MPCC engine can be configured as two flex modes: (a) the straight-forward (20+4) EC mode and (b) the low-latency multi-layer EC mode, for a typical 2RU box of 24 HDD disks.

In the (20+4) EC mode, there are 20 data disks plus 4 parity disks to support the primary storage reliably working under 4 failed disks. The 4 failed disks can be spread over 5 years, on average. As less than 4 disks are failed, there is no need to rebuild the entire failed disk immediately, because of the over-provisioned reliability of 4 failed disks. It degrades to (20+3) EC with 1 bad disk, then (20+2) EC with 2 bad disks, (20+1) EC with 3 bad disks, and 4 bad disks after 4 years. There are no dedicated HDD rebuilding operations (ops) at rush-hours. All the HDDs I/O capacities are available for users' read/write operations (ops).

An embodiment will only perform MPCC-EC rebuilding bad blocks on-the-fly as they are being read by users, then the just-rebuilt blocks would over-write the highest parity blocks. The parity blocks were fragmented with the original parities for untouched areas, and the rebuilt blocks for being read hot areas. There is no rebuilding for hot areas. The cold blocks of dead HDDs are protected by 4 parities for tolerating 4 failures. After 3 failed disks, the system can be rebuilt as (19+1) EC with 4 bad disks, then (18+1) EC, and so on, by reducing effective storage capacity gradually.

In low-latency mode, the MPCC engine is configured to support four of 5+1 RAID5 parities and 5+1 diagonal parities, plus two layers of 10+1 and 20+1 diagonal parities. Therefore, only 5 disk reads are needed to rebuild two failed disks. With 5% more capacity penalty, 3 failed disks can be recovered with 10 disk reads.

The HDD disks can be more effectively used by users without spare disk rebuilding ops. MPCC convolution EC can provide 10× higher computation performance. Flex-MPCC can provide much fewer disk-reads and computation latency than other EC codes.

Over the product lifespan, HDDs will become dead one-by-one, and the overall storage box will continue working without losing capacity for less than 4 disk failures, and thereafter with a loss of capacity, without loss of data or availability. There is no disk-rebuilding for cold data areas/sectors in 5 years with 4 dead disks by 4 parities. There is only rebuilding of hot data sectors on-the-fly (at reading the dead disk sectors moment) and storing of rebuilt sectors for future re-accessing (the higher parities becoming spare sectors). These rebuilt sectors degrade into (20+3), (20+2), (20+1) stripes without storage capacity loss, and then becoming (19+1), (18+1), etc. with capacity loss over the primary storage lifetime. In areas of cold data mixed with hot sectors, new lost sectors can be rebuild from good data, the rebuilt data and whatever available parities. This flex erasure coding storage system can be expanded for protecting (N+m) local HDDs or (N+m) cloud storage nodes or both of the cloud HDDs and clusters.

MPCC convolution EC can provide 10× higher computation performance. It can provide a maintenance-free primary storage HDD box to lower operation costs. Embodiments may be implemented in HDDs primary storage, cloud storage, datacenter servers, and the like.

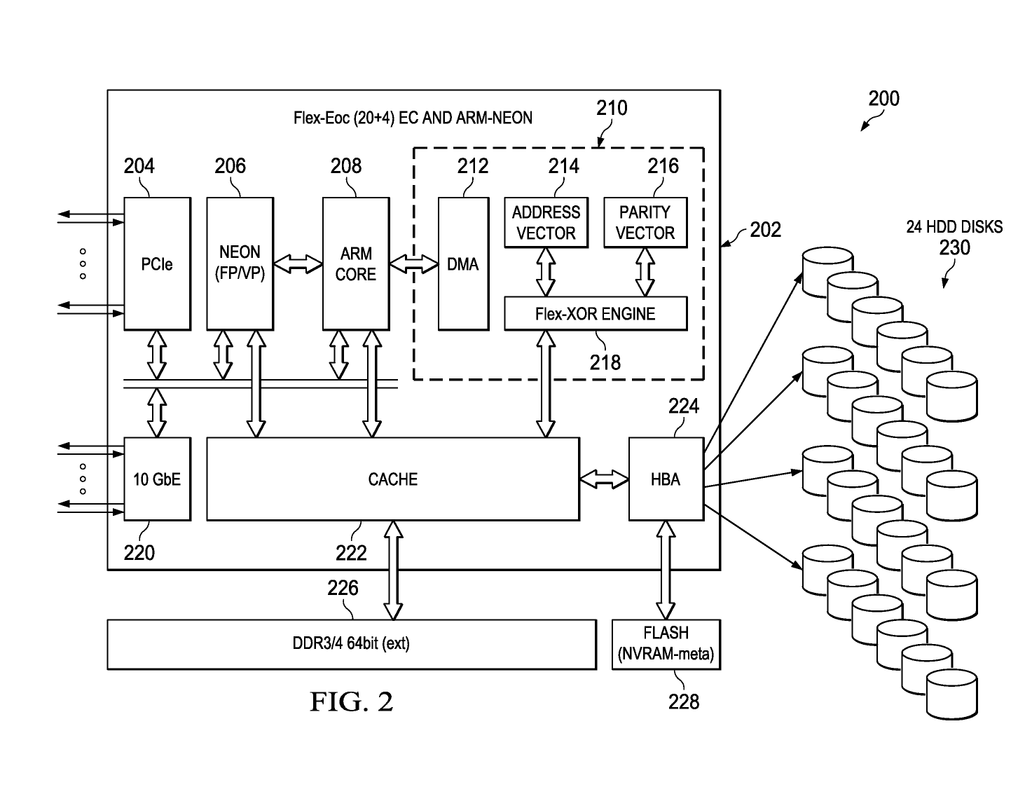

The Flex-EoC controller illustrated in FIG. 2 includes a flexible XOR engine for (20+x) EC by M-parity convolution codes (MPCC) and ARM/NEON cores. The ARM/NEON cores can support open-source erasure coding algorithms in addition to host bus adapter (HBA) interface and flex-EoC management. The flexible XOR engine can support flex-RAID5/6 block coding.

An embodiment provides firmware-selectable RAID5, RAID6, MPCC, RS, and flex-EC coding algorithms. An embodiment dynamically scans all disks and tags bad sectors or blocks to build super-blocks. An embodiment fixes a bad data sector or block on-the-fly, and reshelves the rebuilt data sector or block to checksum location by flexible MPCC EC. In an embodiment, the MPCC EC includes a diagonal parity check system. In an embodiment, the system includes multiple diagonal parities.

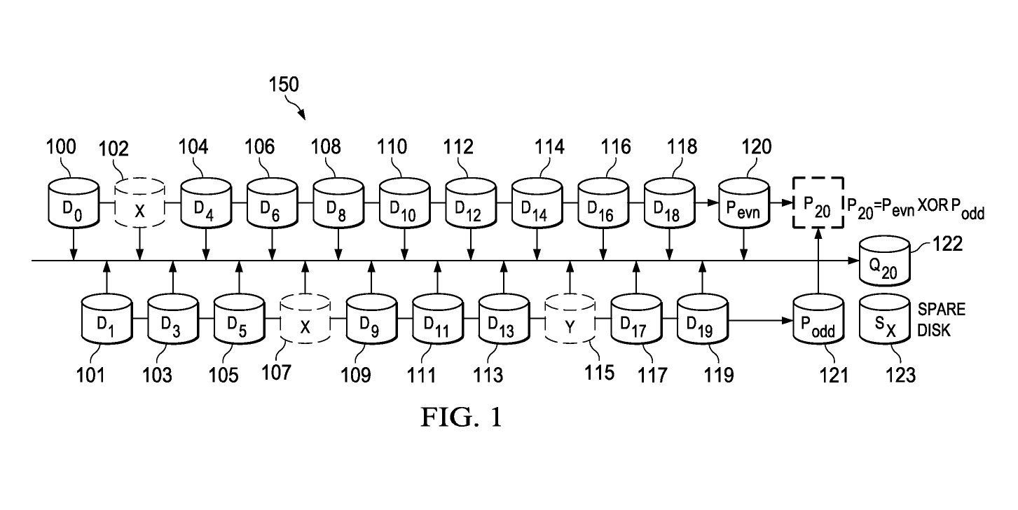

FIG. 1 is a block diagram of an embodiment system 150 of HDDs with a flexible XOR engine that can support Flex-RAID5/6. System 150 includes twenty primary storage HDDs 100-121 and four parity HDDs 120-123. The HDDs 100-121 are arranged as even HDDs 100, 102, 104, 106, 108, 110, 112, 114, 116, 118 and odd HDDs 101, 103, 105, 107, 109, 111, 115, 117, 119 with an even parity HDD 120 (labeled Pₑᵥₑₙ) and an odd parity HDD 121 (labeled P_{odd}). In addition to the Pₑᵥₑₙ HDD 120 and the P_{odd} HDD 121, the parity HDDs also include a spare HDD 123 (labeled Sₓ) and parity HDD 122 (labeled Q20) for RAID6 parity Q. The RAID6 parity P can be calculated as P₂₀Pₑᵥₑₙ̂P_{odd} of the 20 HDDs.

As an example, as shown in FIG. 1, twenty-four HDDs 100-123 can be setup for two of (10+1) RAID5, (20+2) RAID6 with one spare disk. In most cases, only one disk X 102 has failed, and one of the (10+1) RAID5 100, 104, 106, 110, 112, 114, 116, 118, 120 can rebuild it to the spare disk 123 with 10 reads per block repaired. If two disks X 107 and Y 115 fail at the same time, the (20+2) RAID6 can rebuild two disks to the spare disk 123 and over-write used block of Q₂₀ in 20 reads per two disk emergency repaired. The HDDs become vulnerable, and need to replace 2 disks and rebuild Q₂₀ manually. Without maintenance, it degrades into (9+1) RAID5 and (19+2) RAID6, and so on, for reduced storage capacity by reshelf data.

An embodiment RAID5/flex-EC controller has 4x(5+1) with (19+2). For general IT requirements for 24 HHDs prime storage, RAID5 reliability is acceptable, and EC is used for less maintenance. An embodiment modifies the flexible-RAID system disclosed in co-owned U.S. Patent Application Publication No. 2013/0042053, published Feb. 14, 2013 as Flexible-ASE(N+m) with the following features. (1) 4x RAID5 (5+1) stripes overlaid by ASE(19+2) to protect 2 HDD disk loss plus special cases 5 loss. (2) The RAID5 (5+1) stripes will keep the low IOs and latency for 1 HDD disk loss. (3) The ASE(19+2) can protect the 2 HDD disk loss with the P is one of 4 RAID5 parities, Q rotated stored within the 24 HDDs that makes one of 4 RAID5 (5+1) becomes RAID5 (4+1). (4) As one HDD disk dies, the related RAID5 (5+1) will be rebuilt as RAID5 (4+1), then RAID5 (3+1). (5) As one RAID5 becomes (2+1), it will be removed and redistributed rebuilt data blocks to other RAID5 group, even it becomes RAID5 (6+1), as long as enough storage spaces can allow such ops. (6) It also modifies the Q for ASE(18+2) with 1 read of current Q and 1 write of new Q. (7) To rebuild a 2 HDD loss, it uses 19 block reads. (8) Flexible-ASE(19+2) will be reduced to ASE(18+2), (17+2) . . . (10+2), as long as there is enough space to allow the shrinking operations. Then the storage system 150 can continue work without maintenance.

As an example: Q (4+1), (5+1), (5+1), (5+1) rotate (5+1), Q (4+1), (5+1), (5+1) (5+1), Q (4+1), (5+1), (5+1). For 1 loss: x Q(3+1), (5+1), (5+1), (5+1) rotate x (4+1), Q (4+1), (5+1), (5+1). For 3 loss: xxx Q (5+1), (6+1), (5+1) rotate xxx (6+1), Q (5+1), (5+1).

FIG. 2 is a block diagram of an embodiment storage system 200. Storage system includes a flexible EoC (20+4) EC and ARM-NEON 202, external memory 226, a flash memory 228, and twenty-four HDDs 230. Flex-EoC 202 includes a cache 222, a 10 Gigabit (Gb) Ethernet I/O port 220, a Peripheral Component Interconnect Express (PCIe) I/O port 204, a NEON processor 206, an ARM core processor 208, a host bus adapter (HBA) 224, and a Flex-erasure coding controller 210. The Flex-XOR component 210 includes a direct memory access (DMA) 212, an address vector 214, a parity vector 216, and a Flex-XOR engine 218. In an embodiment, the external memory 226 is a 64 bit double data rate (DDR) random access memory (RAM). In an embodiment the ARM core processor 208 is implemented as a reduced instruction set computer (RISC) architecture. In an embodiment, the NEON processor 206 is implemented as a single input, multiple data (SIMD) architecture. The Flex-XOR engine 218 implements the M-parities convolution erasure coding methods to compute M of parities/blocks for encoding, to compute x of syndromes for dead blocks, then to iterate-out x blocks as rebuilt data blocks, where M and x are programmable and managed by 208 ARM-core CPU. The M is the number of over-provisioned parity disks for false tolerance, for example M is 4; x is 1 to M, number of false blocks as users reading RAID stripe from troubled HDDs. In an embodiment, the flex erasure coding controller 210 includes 214 memory address vector and 216 parity vector scratch cache to carry out the basic MPCC erasure coding ops as the first mode and managed by 208 for advanced flex MPCC second mode and third mode ops.

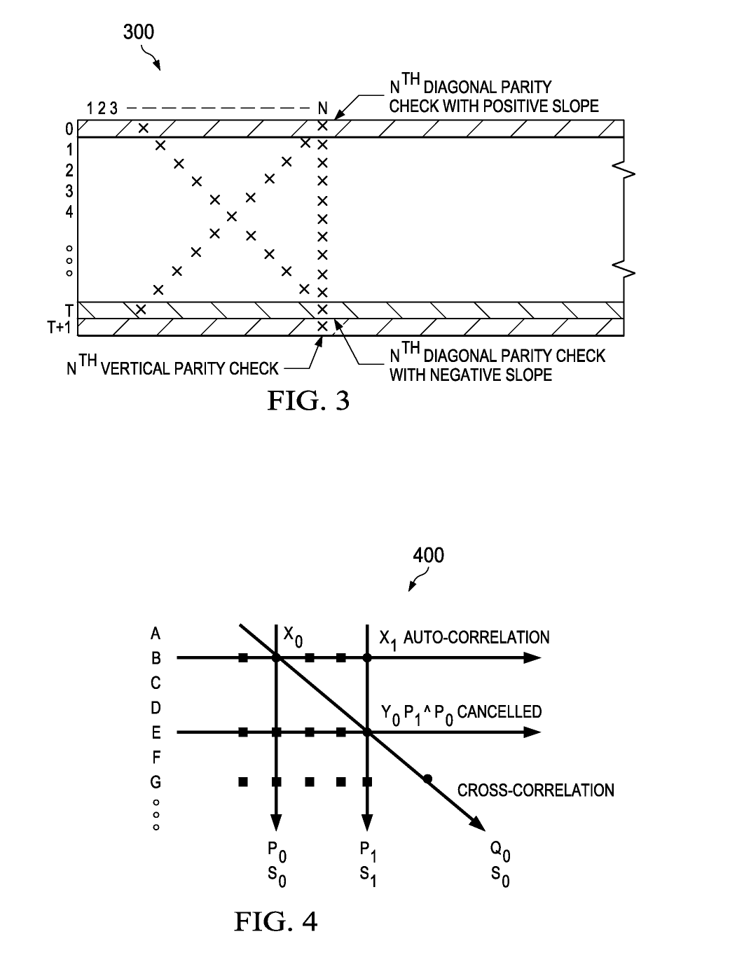

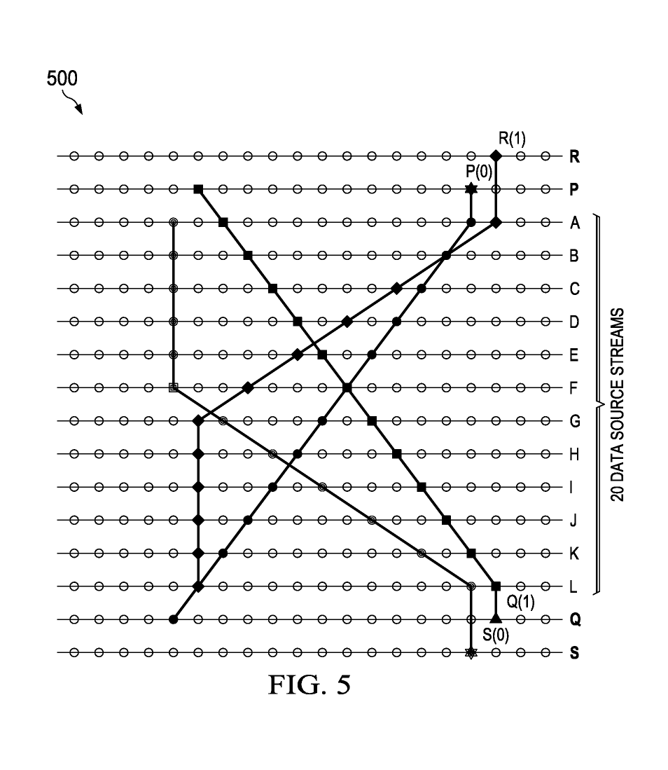

Embodiments of the flexible XOR engine 218 support 3 MPCC convolution coding modes. The first mode is the (20+4) MPCC mode as shown in FIGS. 3-5. FIG. 3 illustrates this mode 300 from U.S. Pat. No. 4,205,324, issued May 27, 1980. FIG. 4 illustrates this mode 400 with iteration decoding: x₁=x₀̂S₁̂S₀. FIG. 5 illustrates this mode 500 with 4-Parity cross-convolution coding, fast for SSE/AVX processing in cache.

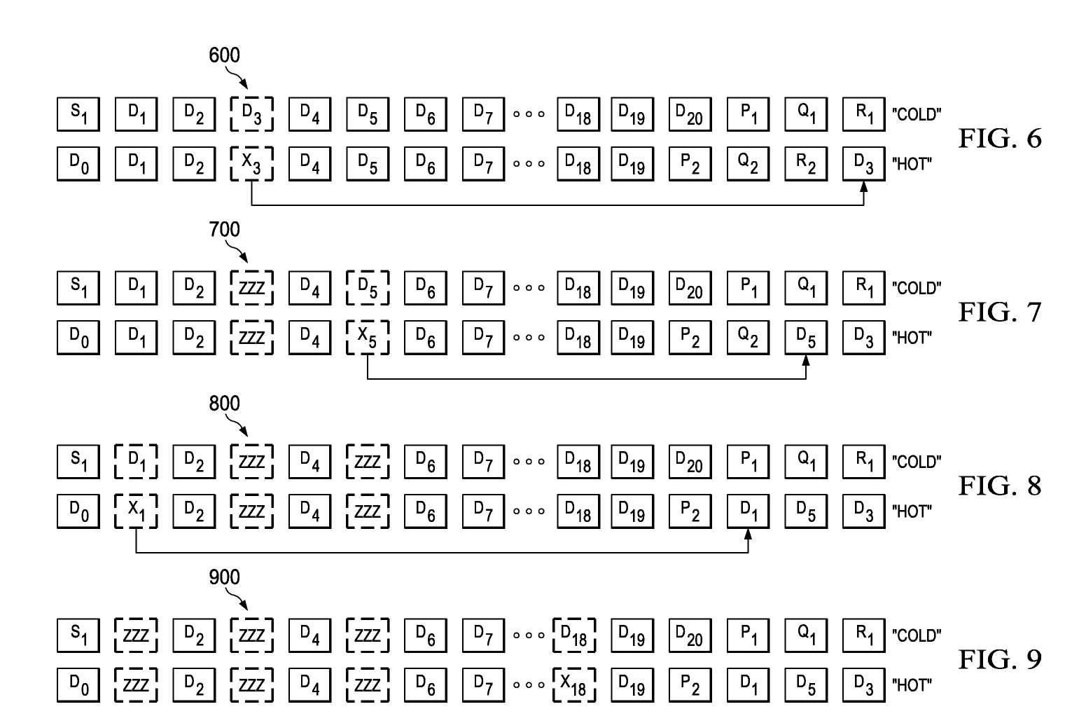

The second MPCC convolution coding mode is the Flex (20+x) MPCC mode as shown in FIGS. 6-9. The workflow is Flex (20+4) EC degrading to (20+1) EC, then (N+2) EC. In FIG. 6, in system 600, Disk D₃ failed→X₃ that is being fixed by 20 reads with 1/24 chance, then overwrites parity S₄. (20+4) EC→(20+3) EC. In system 700 in FIG. 7, Disk D₅ failed→X₅ that is being fixed, then overwrites parity R₂ . (20+3) EC→(20+2) EC. The cold is still (20+4) EC. In system 800 in FIG. 8 Disk D₁ failed→X₁ that is being fixed, then overwrites parity Q2. (20+2) EC→(20+1) EC. The cold is still (20+4) EC. Read hot D₁, D₃, D₅ again becomes normal ops without 20 reads latency, penalty. It self-healed at the first read dead block. Read cold blocks in dead disks D₁, D₃, D₅ need (20+4) MPCC convolution coding to rebuild them, up to 4 erasures. In system 900 in FIG. 9, more than 3 disk failures, one-by-one over years, the rebuilt hot blocks are reshelved to good disks, as Flex (N+2) EC. Flex (N+2) EC, where N is 19, 18, . . . , and so on, to trade-off storage capacity for reliability and availability of primary storages.

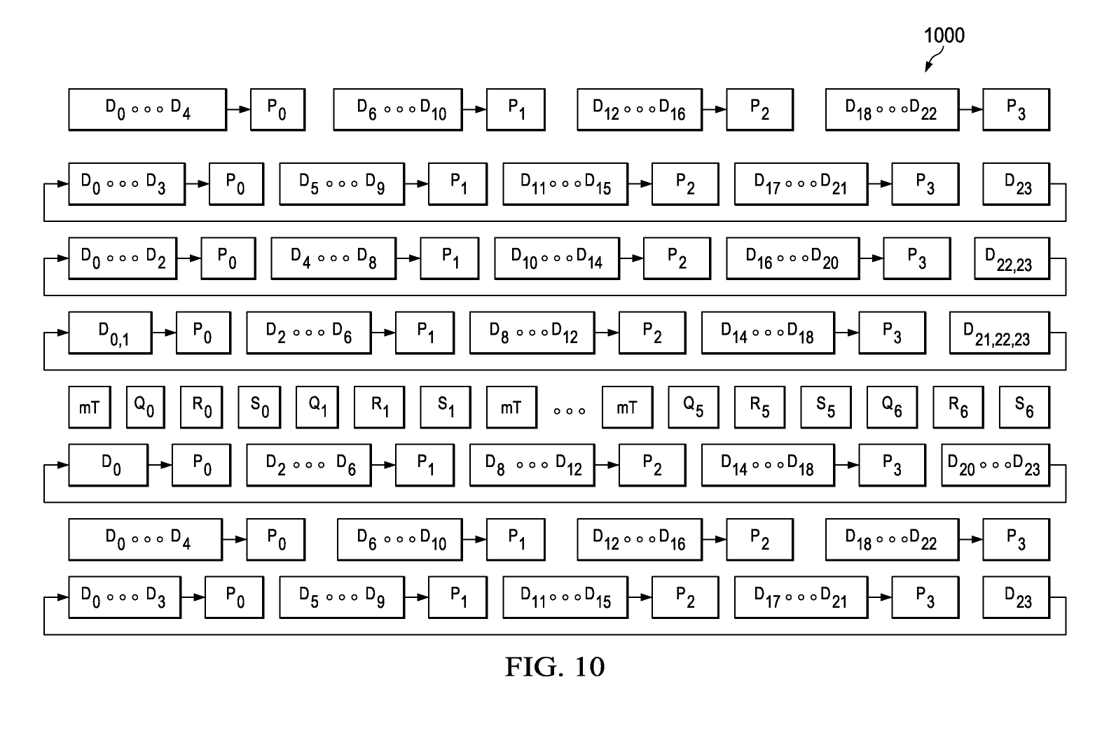

The third MPCC convolution coding mode 1000 is the Flex low-latency MPCC mode as shown in FIG. 10. Super Block: 7 of (4×5 MB) RAID5 per stripe. (1) Super Block (SB): (20+4) MPCC setup as 1 MB/block, 4×5 MB/stripe, 7 stripes/SB plus 24 blocks of 3-metadata, MPCC keys, plus 7x Q, R, S parities to optimize the disk IO performance and HDDs availability. (2) (8×4×5 MB) SB can support various 512B or 4 KB sub-blocks that marked by metadata and MPCC key associated to small files because that MPCC is convolution coding by streaming XOR ops in 64 to 256 bit/unit up on external DIMM bus width. (3) A hot block in dead disk only needs 5 reads of RAID5 XOR, then healed and reshelf to one of related Q, R, S blocks; and a cold block will use (20+4) MPCC to fix 3 or 4 erasures with Q, R, S, and aggregated P=P₁̂P₂̂P₃̂P₄ RAID5 parities; a deleted block will use (20+x) MPPC to calculate x of parities P, Q, R, S for writing block, as x=4,3,2,1 in previous cases.

An embodiment single Flex (20+4) MPCC provides over-provision reliability for 4 erasures such that no need to rebuild entire dead disks, but instead fixes a dead block on-the-fly (i.e., without taking a disk off line or halting read-write operations) whenever it is being read. It also can double a primary storage's availability.

For 20% static cold blocks, the (20+4) MPCC can tolerate up to 4 dead disks with excellent availability. For 60% dynamically deleted blocks, the (20+x) MPCC can tolerate (4-x) dead disks, where the variable x is just available redundant disks for P, Q, R, S parities when they being written (ex: x=4,3,2,1). For 20% dynamic hot blocks, it starts as (20+4) MPCC in the beginning; within primary storage lifespan: 1 disk failed, it becomes (20+3) MPCC with the just-rebuilt blocks overwritten at S-block locations; 2 disks failed, it becomes (20+2) MPCC with the just-rebuilt blocks overwritten at R-blocks; 3 disks failed, it becomes (20+1) MPCC with the just-rebuilt blocks overwritten at Q-blocks; and 4 or more failed, it goes down to (N+2) MPCC with degraded P,Q-blocks and reshelf rebuilt blocks, N=18, 17, . . . The healed hot blocks will be read normally without costly rebuilding ops, and without latency delay. In fact, those higher order parity Q, R, S blocks become spare blocks for hot daily activities, auto-healing. As a penalty, it takes 20 reads to rebuild a dead block with (20%*1/24) odd hit by a hot read.

An embodiment flex low-latency MPCC hybrid four (5+1) RAID5 has a (20+x) MPCC, x=4,3,2. For 20% cold and 60% replaced blocks, preview (20+4) MPCC and (20+x) MPCC can still be used. For 20% hot blocks, it takes 5 reads to fix 1 dead block, and 20 reads to fix 2, 3, 4 dead blocks as in FIG. 10.

Flex-EoC by MPCC can tolerate 4 failed disks, with much higher reliability. Rebuilding entire disks blankly in rush-hours as a disk fails is not needed because of over-provision reliability. Embodiments can double HDDs availability. HDD disks can be more effectively used without rebuilding to spare disks. An embodiment provides a maintenance-free primary storage system. As disks fail, the static cold blocks are over-protected for 4 failures. The dynamic hot blocks are protected by flex low-latency MPCC.

MPCC convolution EC can provide 10× higher computation performances of conventional block EC algorithms, much cheaper for ASIC implementation. It is flexible and maintenance-free for next generation HDD controller to low operation costs. Flex-MPCC can provide much less latency of on-the-fly block-rebuilding ops than conventional erasure coding algorithms. Flex-EoC is programmable for many open-source erasure coding algorithms.

Over primary storage lifespan, the disks will be dead one-by-one gradually. The overall storage box will keep running without losing HDDs availability and capacity up to 4 disk failures. For more dead disks, the Flex-MPCC trades off the capacity for reliability without losing data or availability.

An embodiment provides a self-healing system by only rebuilding necessary blocks on-the-fly as they are read. For hot blocks, it takes the over-provision parity blocks as spare blocks to save the just-being-rebuilt blocks for further normal reads.

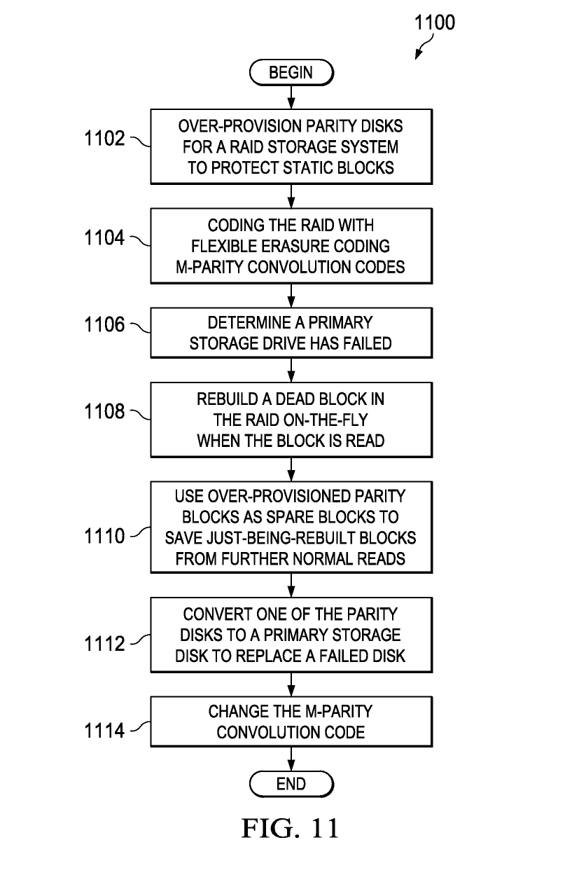

FIG. 11 is a workflow chart of an embodiment method 1100 for storage management. Method 1100 begins at block 1102 where the system over-provisions parity disks for a RAID storage system to protect static blocks in the primary storage disks. At block 1104, the system codes the RAID with flexible erasure coding M-parity convolution codes. At block 1106, the system determines that a primary storage drive has failed. At block 1108, a dead block in the RAI is rebuilt by the system on-the-fly when the block is read. At block 1110, over-provisioned parity blocks are used as spare blocks to save just-being-rebuilt blocks from further normal reads. At block 1112, one of the parity disks is converted to a primary storage disk to replace a failed primary storage disk. At block 1114, the M-parity convolution code is changed to correspond to the current number of parity disks, after which, the method 1100 ends. In an embodiment, the number of parity disks is equal to M, where is the number of the M-parity convolution codes.

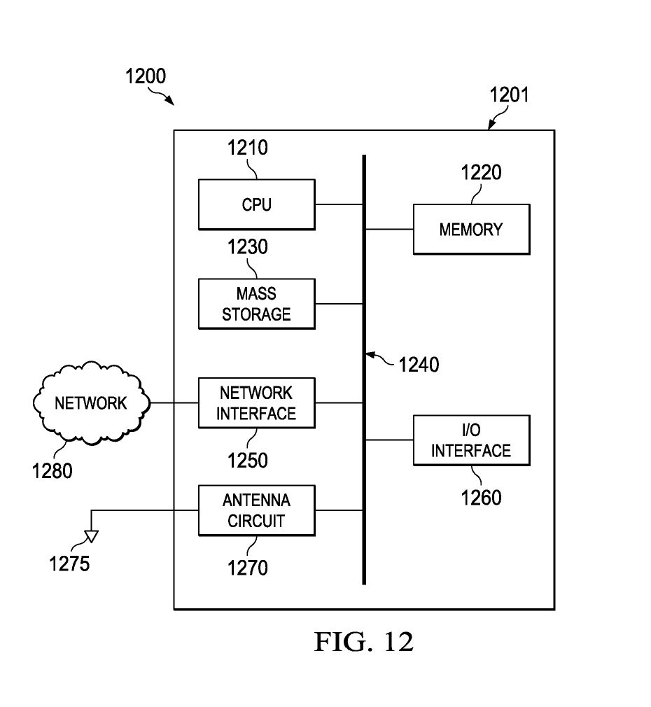

FIG. 12 is a block diagram of a processing system 1200 that may be used for implementing the devices and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 1200 may comprise a processing unit 1201 equipped with one or more input/output devices, such as a speaker, microphone, mouse, touchscreen, keypad, keyboard, printer, display, and the like. The processing unit 1201 may include a central processing unit (CPU) 1210, memory 1220, a mass storage device 1230, a network interface 1250, an I/O interface 1260, and an antenna circuit 1270 connected to a bus 1240. The processing unit 1201 also includes an antenna element 1275 connected to the antenna circuit.

The bus 1240 may be one or more of any type of several bus architectures including a memory bus or memory controller, a peripheral bus, video bus, or the like. The CPU 1210 may comprise any type of electronic data processor. The memory 1220 may comprise any type of system memory such as static random access memory (SRAM), dynamic random access memory (DRAM), synchronous DRAM (SDRAM), read-only memory (ROM), a combination thereof, or the like. In an embodiment, the memory 1220 may include ROM for use at boot-up, and DRAM for program and data storage for use while executing programs.

The mass storage device 1230 may comprise any type of storage device configured to store data, programs, and other information and to make the data, programs, and other information accessible via the bus 1240. The mass storage device 1230 may comprise, for example, one or more of a solid state drive, hard disk drive, a magnetic disk drive, an optical disk drive, or the like.

The I/O interface 1260 may provide interfaces to couple external input and output devices to the processing unit 1201. The I/O interface 1260 may include a video adapter. Examples of input and output devices may include a display coupled to the video adapter and a mouse/keyboard/printer coupled to the I/O interface. Other devices may be coupled to the processing unit 1201 and additional or fewer interface cards may be utilized. For example, a serial interface such as Universal Serial Bus (USB) (not shown) may be used to provide an interface for a printer.

The antenna circuit 1270 and antenna element 1275 may allow the processing unit 1201 to communicate with remote units via a network. In an embodiment, the antenna circuit 1270 and antenna element 1275 provide access to a wireless wide area network (WAN) and/or to a cellular network, such as Long Term Evolution (LTE), Code Division Multiple Access (CDMA), Wideband CDMA (WCDMA), and Global System for Mobile Communications (GSM) networks. In some embodiments, the antenna circuit 1270 and antenna element 1275 may also provide Bluetooth and/or WiFi connection to other devices.

The processing unit 1201 may also include one or more network interfaces 1250, which may comprise wired links, such as an Ethernet cable or the like, and/or wireless links to access nodes or different networks. The network interface 1201 allows the processing unit 1201 to communicate with remote units via the networks 1280 to form cloud storage clusters or distributed disaster recovery storage systems. For example, the network interface 1250 may be fiber channel, iSCSI, Infiniband or other cloud networking gears, even long-haul fiber gears for geo-distributed disaster recovery systems. In an embodiment, the processing unit 1201 is coupled to a local-area network or a wide-area network for data processing and communications with remote devices, such as other processing units, the Internet, remote storage facilities, or the like.

The following references are related to subject matter of the present application. Each of these references is incorporated herein by reference in its entirety:
U.S. Pat. No. 4,205,324, issued May 27, 1980.
U.S. Patent Appl. Publ. No. 2013/0042053, published Feb. 14, 2013.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A storage system comprising:
an over-provisioned redundant array of independent disks (RAID); and
a flexible erasure coding controller coupled to the RAID, the controller comprising a flexible exclusive-or engine configured to provide erasure coding for the over-provisioned RAID using M-parity convolution codes.

2. The storage system of claim 1, wherein the RAID comprises a plurality of primary storage disks and a plurality of parity disks.

3. The storage system of claim 2, wherein flexible erasing coding controller causes one of the parity disks to become a primary storage disk when one of the primary storage disks fails.

4. The storage system of claim 1, wherein the flexible erasure coding controller fixes a dead block when the dead block is being read.

5. The storage system of claim 1, wherein a number of parity disks is equivalent to M.

6. The storage system of claim 1, wherein a convolution code used by the flexible erasure coding controller changes when a parity disk is converted into a primary storage disk.

7. The storage system of claim 1, wherein the convolution code comprises a diagonal parity check system with multiple diagonal parities.

8. A method of managing storage in a data processing system, the method comprising:
protecting static blocks in a redundant array of independent disks (RAID) with over-provisioning of over-provisioned parity disks;
coding the RAID with a flexible erasure coding with M-parity convolution codes (MPCC);
rebuilding a dead block in the RAID on-the-fly when the block is read; and
using, for hot blocks, over-provisioned parity blocks as spare blocks to save just-being-rebuilt blocks for further normal reads.

9. The method of claim 8, wherein a number of over-provisioned parity disks is equal to M.

10. The method of claim 8, further comprising converting one of the over-provisioned parity disks to a primary storage disk when one of the primary storage disks fails.

11. The method of claim 8, further comprising changing a convolution code when one of the over-provisioned parity disks is converted into a primary storage disk.

12. The method of claim 8, wherein MPCC comprises a diagonal parity check system with multiple diagonal parities.

13. A network component configured to manage a storage system, comprising:
a processor; and
a computer readable storage medium storing programming for execution by the processor, the programming including instructions to:
over-provision a redundant array of independent disks (RAID) with over-provisioned parity disks to protect static blocks in the RAID;
code the RAID with a flexible erasure coding with M-parity convolution codes (MPCC);
rebuild a dead block in the RAID on-the-fly when the block is read; and
use, for hot blocks, over-provisioned parity blocks as spare blocks to save just-being-rebuilt blocks for further normal reads.

14. The network component of claim 13, wherein a number of over-provisioned parity disks is equal to M.

15. The network component of claim 13, wherein the programming further comprises instructions to convert one of the over-provisioned parity disks to a primary storage disk when one of the primary storage disks fails.

16. The network component of claim 13, wherein the programming further comprises instructions to change a convolution code when one of the over-provisioned parity disks is converted into a primary storage disk.

17. The network component of claim 13, wherein MPCC comprises a diagonal parity check system with multiple diagonal parities.
